(19) United States
(12) Patent Application Publication
(10) Pub. No.: US 2005/0142438 A1
(43) Pub. Date: Jun. 30, 2005

(54) Hydrogen generating apparatus and methods

(76) Inventors: George H. Johnson, Palmyra, PA (US); Michael B. Johnson, Wilmington, DE (US); William L. Johnson, Bear, DE (US)

Correspondence Address: NIXON & VANDERHYE, PC, 1100 N GLEBE ROAD, 8TH FLOOR, ARLINGTON, VA, 22201-4714, US

(21) Appl. No.: 10/893,488

(22) Filed: Jul. 19, 2004

Related U.S. Application Data
(60) Provisional application No. 60/488,091, filed on Jul. 18, 2003.

(51) Int. Cl. H01M 6/30

(52) U.S. Cl. 429/111

(57) ABSTRACT

A photogalvanic system having a reactor cell with a lighted region and a darkened region; an aqueous electrolyte solution contained in the reactor cell, said aqueous electrolyte solution containing a photoredox catalyst; an electrode having a anodic end and a cathodic end, said single electrode being immersed in the aqueous electrolyte solution whereby the anodic end resides in the lighted region and the cathodic end resides in the darkened region; a light source for irradiating the contents of the lighted region with visible light; and a baffle interposed between the lighted region and the darkened region, said baffle adapted to block light irradiated in the lighted region from entering into the darkened region and adapted to allow the aqueous electrolyte solution to flow between the lighted region and the darkened region.

### CROSS REFERENCE TO RELATED PATENT APPLICATION

This patent application is related to, and claims the benefit of, U.S. Provisional Patent Application No. 60/488,091, the entire disclosure of which is incorporated herein by reference.

### FIELD OF THE INVENTION

The present invention relates to a hydrogen generating apparatus for producing hydrogen, which, for example, may be stored and/or supplied to a fuel cell or the like.

### BACKGROUND OF THE INVENTION

In the production of hydrogen for use as a fuel, the most desirable approach is the conversion of water to hydrogen and oxygen by use of sunlight. The splitting of water to produce hydrogen for use in fuel cells takes place by the very expensive conventional electrolysis using fossil fuel, nuclear, wind, solar, bio-mass and hydroelectric fuels as energy sources. The splitting of water can also occur via the less expensive photo-galvanic process via: 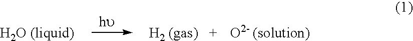
Fuel cells convert the intrinsic chemical free energy of a hydrogen-based fuel (low temperature operation) directly into DC current in a continuous catalytic process. Most fuel cell reactions involve a combination of hydrogen (H) and oxygen (O), shown below:
H₂(gas)+½O₂(gas)→H₂O (liquid) (2)

Hydrogen is conventionally produced for chemical and industrial purposes by converting materials such as hydrocarbons and methanol in a reforming process to produce a synthesis gas. Such production usually takes place in large industrial facilities The operation of the industrial hydrogen production facilities is often integrated with associated facilities to improve the use of energy for the overall complex. Synthesis gas is the name generally given to a gaseous mixture principally comprising carbon monoxide and hydrogen, but also possibly containing carbon dioxide and minor amounts of methane and nitrogen. It is used, or is potentially useful, as feedstock in a variety of large-scale chemical processes, for example: the production of methanol, the production of gasoline boiling range hydrocarbons by the Fischer-Tropsch process, and the production of ammonia. Processes for the production of synthesis gas are known and generally comprise steam reforming, autothermal reforming, non-catalytic partial oxidation of light hydrocarbons or non-catalytic partial oxidation of any hydrocarbons. Of these methods, steam reforming is generally used to produce synthesis gas for conversion into ammonia or methanol. In such a process, molecules of hydrocarbons are broken down to produce a hydrogen-rich gas stream.

Molecular approaches for converting sunlight to electrical energy have a rich history with measurable “photoeffects” reported as early as 1887. One class of molecular-based solar cells are the so-called photogalvanic cells that were the popular molecular level solar energy conversion devices of the 1940's-1950's Photogalvanic cells are devices that convert light directly into electrical energy. Such cells rely upon the excitation of a molecule by an absorbed photon to induce chemical reactions which yield high-energy products. These high-energy products subsequently lose their energy electrochemically. Such reactions are generally known as reversible, endergonic photochemical processes, which means reactions which are pushed uphill with light. Typically, photogalvanic cells contain two electrodes which are placed in an electrolyte solution. The electrolyte solution contains chemical species sufficient to provide reversible redox reactions under light illumination. Typical ingredients in an electrolyte are a photoreducible or photooxidizable dye and a redox couple. Usually, one of the electrodes is maintained in the dark and the other is illuminated, but this is not always necessary.

Prior photogalvanic cells employ a general strategy of dye sensitization of electrodes embedded in a membrane that allows ion transfer and charge transfer; the membrane physically separates two dark metal electrodes and photogenerated redox equivalents. The geometric arrangement precludes direct excited-state electron transfer from a chromophore to or from the electrodes. In particular, intermolecular charge separation occurs and the reducing and oxidizing equivalents diffuse to electrodes where thermal interfacial electron transfer takes place. The conventional photogalvanic cell based on light-sensitive materials in solution typically comprises an aqueous electrolyte solution containing an organic dyestuff, a metal redox couple, and a common acid. The instant invention specifically relates to the addition to the electrolyte solution in such photogalvanic cells of one or more complexing agents for the higher valent ion of the metal redox couple present. It has been previously proposed to add a complexing agent to a mixture of a photo-reducible dyestuff and a metal redox couple. However, this earlier work was concerned with the irreversible storage of energy through separation of high energy state products by precipitation of the metal ion complex, not with the use of such agents in a reversible photogalvanic cell.

Another known process for the production of hydrogen involves the photogalvanic effect of a polyacid ion and comprises immersing an anode into an aqueous solution of an alkylammonium salt of polytungstic acid or polyvanadic acid as an anode electrolyte, immersing a cathode into an aqueous solution of an acid as a cathode electrolyte, isolating both said aqueous solutions to each other, electrically connecting both said electrodes to each other, and irradiating a light onto said anode electrolyte, whereby hydrogen is evoluted at said cathode. Such a process is based on the observation that when an aqueous solution containing an alkylammonium salt of polytungstic acid or polyvanadic acid is used as an anode electrolyte, and light corresponding to the absorption light of the polyacid ion is irradiated onto the above aqueous solution, there is produced a large potential difference between the irradiated part of the solution and the non-irradiated part of an electrolyte present in a dark chamber during the light irradiation (which is called the photogalvanic potential) and in addition there is produced in the electrolyte an active material which reacts at the anode. The irradiated part always indicates a negative potential with respect to the non-irradiated part. As a result, hydrogen gas may be produced from water by the reduction of proton (H.⁺) utilizing the above mentioned high reduction force of the active material.

There has recently been increased interest in photogalvanic cells for converting sunlight or solar energy into usable electrical energy. Those photogalvanic systems which are based upon iron-thionine have received particular attention. As the name implies, these photogalvanic systems depend upon electrolytes containing thionine, a photoreducible dye, and salts of iron which serves as the redox couple. Despite this increased interest in photogalvanic cells in general, and iron-thionine cells in particular, engineering efficiencies which have heretofore been obtained have been so low that these cells have not been viable competitors to other methods for converting solar energy into usable electrical energy. Low cell efficiencies are the result of several problems, including the narrow range of the solar spectrum which is absorbed, and therefore usable. In fact, only a fraction of the sunlight incident upon a photogalvanic cell is actually absorbed in the typical case. In the case of the iron-thionine systems, for example, it has been estimated that only about 10% of the total incident solar spectrum is absorbed by the thionine dye.

The above general strategies for hydrogen production have been employed in many guises over the years, but the absolute efficiencies remain low. A basic difficulty with all the aforesaid devices and techniques is the low yield of energy out compared with the light energy put into the system. If solar energy is to be used at all, the conversion efficiency must be improved. The voltages obtained are generally below 300 mV and the power levels obtained are at the most a few dozen μwatts/cm². Further, when the relay system is in an organic constituent the liquid loses it stability after a few minutes. Conversely, with relay systems constituted by Fe²⁺/Fe³⁺ good stability is obtained, but then the power of the cell does not exceed 1 μW/cm². Methods for producing hydrogen from renewable energy resources need development. While wind, solar, and geothermal resources can produce hydrogen electrolytically, and biomass can produce hydrogen directly, other advanced methods for producing hydrogen from renewable and sustainable energy sources without generating carbon dioxide are still in early research and development phases. Processes such as thermo-chemical water splitting, photoelectrochemical electrolysis, and biological methods will require long-term focused efforts to move toward commercial readiness. Renewable technologies, such as solar, wind, and geothermal, need further development for hydrogen production to be more cost-competitive from these sources.

Photogalvanic devices possess other disadvantages. First, because of the requirement that water be decomposed with the formation of gaseous hydrogen, the device is sensitive only to radiation energetically sufficient to effect this decomposition. Photogalvanic devices cannot, for instance, satisfactorily convert visible light to electrical energy since visible light is of insufficient energy to liberate gaseous hydrogen from water to any significant degree. Further, the device must include a gas-tight vessel in which both a liquid electrolyte phase and a gaseous hydrogen phase are present. Because of the requirements for a gas space and for the anode to be at the liquid-gas interface, severe restrictions are placed on the design of the cell. Further, the anode must be catalytically active towards hydrogen so that a low over voltage for the oxidation of hydrogen to hydrogen ion is achieved.

### SUMMARY OF THE INVENTION

It is accordingly an object of the present invention to provide a hydrogen generating apparatus capable of producing hydrogen gas by effectively utilizing low photon sources such as natural sunlight via the photogalvanic effect. It is a further object of the invention to provide a hydrogen generating apparatus capable of supplying a constant concentration hydrogen gas while keeping the concentration of byproducts low, regardless of whether the production amount is large or small. One or more of these objects and other attendant advantages may be achieved by the present invention.

Prior photogalvanic devices and systems required the use of complex pH chemistries, Pt catalysts, photosensitizers to enable the photogalvanic production of hydrogen, two electrodes connected by a conductive element and light and dark regions separated by an ion conducting membrane that prevents the electrolyte solutions in each of the regions for fluid contact with each other. Further, such devices focused on utilizing photons in the range of 200 to 400 nm wavelength.

In contrast to the prior art, new and improved photogalvanic devices have been discovered. These devices are not only sensitive to visible light, which makes them of utility for the conversion of natural daylight to electricity, but are of such compact and simple construction as permits their practical utilization for such energy conversion. In the present invention, it has been found that solutions of polyoxometalates can be employed in a novel photogalvanic device configuration in which one of two electrodes are illuminated provided that the electrodes are constructed of the materials set forth below such that they will have a different readiness to react with light-excited polyacid species formed in the solution when illuminated. As a result, the novel design described below affords compact photogalvanic cells of simple construction employing the light-sensitive polyoxometalates.

The photogalvanic apparatus of the present invention enables the production of hydrogen using highly focused photon sources. The apparatus maximizes the effective features of photogalvanic reactions using one reaction region and one electrolyte solution, thereby requiring no additional chemical catalysts to control the production of hydrogen. The apparatus produces hydrogen from a large range of photon spectrum inputs ranging from 200 nm to 700 nm. The apparatus can produce hydrogen with focused photon power levels as low as 1.0 mW/cm².

Additional objects and attendant advantages of the present invention will be set forth, in part, in the description that follows, or may be learned from practicing or using the present invention. Various objects and advantages may be realized and attained by means of features described below and pointed out in the appended claims. It is to be understood that the foregoing general description and the following detailed description are exemplary and explanatory only and are not to be viewed as being restrictive of the invention, as claimed.

### BRIEF DESCRIPTION OF THE DRAWINGS

The accompanying drawings, which are incorporated in, and constitute a part of the specification, illustrate embodiments of the present invention and, together with the description, serve to explain the principles of the present invention.

FIG. 1 depicts an embodiment of the photogalvanic apparatus or system according to the present invention.

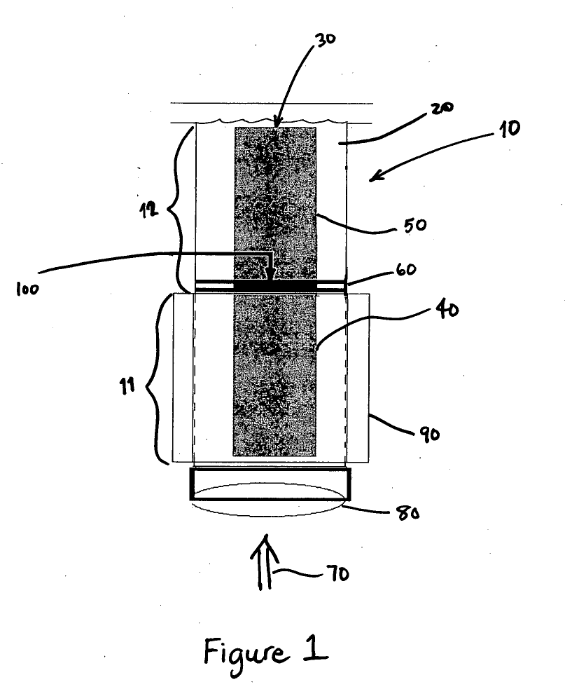

FIG. 2 depicts various baffle configurations according to the present invention.

### DESCRIPTION OF PREFERRED EMBODIMENTS

All patents, patent applications and literatures cited in this description are incorporated herein by reference in their entirety. In the case of inconsistencies, the present disclosure, including definitions, will control.

The present invention comprises an apparatus and method of using same that will produce hydrogen using a low power photon input in the 250 nm to 700 nm range of the spectrum. Referring to the Figures, the photogalvanic device of the present invention comprise one reactor chamber 10 with a common solution 20 in each region of the apparatus. It is believed that this feature is distinguished from the prior art that required different chemistries such as pH or catalysts in each region. The reactor chamber 10 has a lighted region 11 and a darkened region 12. Further, the reaction chamber containing the photo anode portion 40 of the electrode 30 and the cathode portion 50 of the electrode 30 has a novel separator or baffle 60 that allows photon input at the photo anode portion 40 or lighted region but blocks photon input at the cathode portion 50. It is believed that this feature overcomes the prior art that failed to block the photon input to the cathode region. Additionally the baffle 60 does not block the fluid flow the solution 20 between the region of photon anode 40 and the cathode portion 50. The photogalvanic apparatus of the present invention takes advantage of the photo anode portion and cathode portion geometries to maximize the interaction of the photo anode and the aqueous electrolyte solution to produce hydrogen. These and other features are useful to produce hydrogen on a continuous basis from the photon inputs.

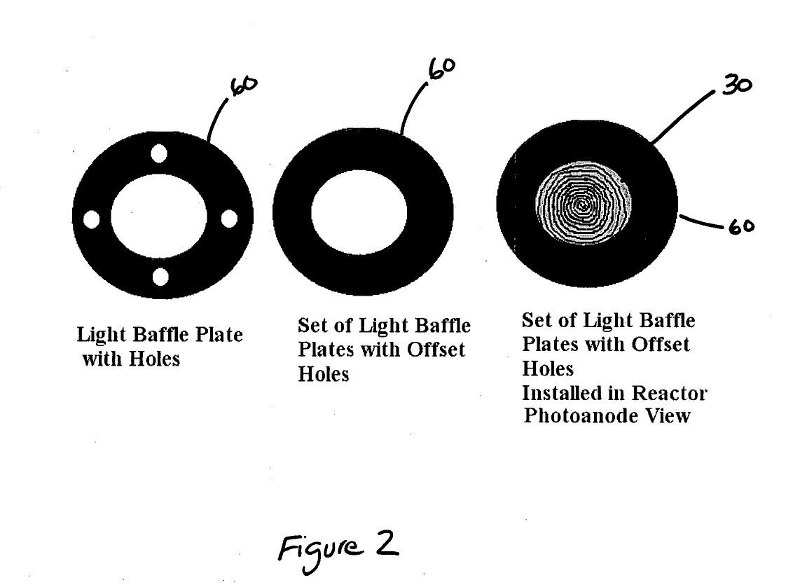

According to the invention, a preferred Pt-anode/cathode electrode comprises a single, unitary structure. The cathode and anode portions of the electrodes are preferably interchangeable to ensure electronic transfers with maximum rapidity, are chemically inactive, and have a minimum over voltage and a minimum ohmic resistance. It is believed that the volume and available surface area of a Pt mesh structure, the geometry and the mechanical characteristics of the Pt structures maximize the hydrogen production by maximizing the interaction of the Pt with the solution in the photo anode region. In a preferred apparatus of the present invention preferably employs a scrolled (i.e., cylindrically/spirally wrapped) Pt wire mesh, as shown in FIG. 2. The scrolled structure optimizes the photo anode production site by provide greater surface area for receiving photons from the light source 70 through lens 80. Optionally, a cylindrical mirror 90 may be employed to focus light into the lighted region 11. Moreover, using the cylindrical wrapped Pt structure also allows for the continuous monitoring of voltage, inductance and amperage. These parameters are useful in monitoring the photogalvanic process. The apparatus is well suited for maximizing photon input from the sun, laser or lamp source and concentrating the source by means of a concentrating lens.

In a preferred embodiment, the present invention provides a photogalvanic apparatus or system comprising a reactor cell having a lighted region and a darkened region; an aqueous electrolyte solution contained in the reactor cell that comprises water and a photoredox catalyst; an electrode made of a precious metal, such as platinum, immersed in the aqueous electrolyte solution and extending from the lighted region to the darkened region; a light source for irradiating the contents of the lighted region with visible light to drive an endergonic reaction for the photodissociation of water into hydrogen and oxygen; and a light baffle for (1) separating the lighted region from and the darkened region, (2) blocking light from the lighted region from entering into the darkened region and (3) allowing the aqueous electrolyte solution to flow between the lighted region and the darkened region. In the photogalvanic system of the present invention, the catalyst may comprise a polyoxometalate, a photoreducible dye, a photooxidizable dye, and the like. Moreover, the electrodes are essentially inert conductive elements of the type generally employed in electrolytic and electrochemical processes. Precious metals such as platinum or palladium and the like may be employed for this purpose or, alternatively, the said electrodes may comprise a conductive base which is coated on the outside with a film of one or more metal oxides. The apparatus of the present invention is designed to effectively use available photon input from sunlight in the 200 to 700 nm region to produce hydrogen. In a preferred embodiment, the photogalvanic production of hydrogen is achieved spectrum point of about 501.6 nm, which is the Helium emission line from hydrogen nuclear fusion process powering the sun. The peak energy input from solar radiation is at 501.6 nm.

There are two defined regions of photon input and photon blocked. It is believed that this feature maximizes the photogalvanic process. Further, no acid bath at pH<1 is necessary for the operation of the photogalvanic apparatus of the present invention.

Although many of the known excitable photoredox reagents may be employed as reagents in the electrolyte solution, the basic requirement for suitable reagents is that they be capable of undergoing a reversible, endergonic photochemical reaction in response to illumination with and removal from sunlight or other photon source. Preferably polyoxometalate (heteropoly) catalysts are employed in the electrolyte solution. Heteropoly electrolytes are members of a very large class of polynuclearoxo complexes (isopoly and heteropoly anions) of the transition metals of Groups V and VI, especially molybdenum, tungsten, and vanadium. Some representative examples are: isopolyanions [Mo₆O₁₉]³⁻, [Mo₇O₂₄]⁶⁻, [H₂W₁₂O₄₀]⁶⁻, and heteropolyanions [PW₁₂O₄₀]³⁻, [CeMo₁₂O₄₂]⁸⁻. The structure of such polyanions is commonly represented as assemblages of MO₆ octahedra (M being addenda atoms of Mo⁶⁺, W⁶⁺, or V⁵⁺) which share edges, corners and occasionally faces with each other and with the XOₙ polyhedra that contain the heteroatom. In general, heteropoly complexes are large (10 to 25 Å), heavy (molecular weights up to 8000), discrete, anionic species. They are anions of strong acids (pK=1 to 4), and their salts and free acids are soluble in water and a wide range of organic solvents. Many heteropolyanions are oxidizing agents. They are easily reduced to the intensely colored heteropoly blue which is a mixed valence species (e.g., W^{5+,6+}) isostructural with the parent anion of higher oxidation state. Several structural types of heteropolyoxometalate complexes are known. Suitable non-limiting examples of such catalytic structures useful in the apparatus of the present invention include:

| | |
|---|---|
| [X⁺ⁿM₁₂O₄₀]⁻⁽⁸⁻ⁿ⁾ | [X⁺ⁿMO₂₄]⁻⁽¹²⁻ⁿ⁾ |
| [X₂⁺ⁿM₁₈O₆₂]⁻⁽¹⁶⁻²ⁿ⁾ | [X⁺ⁿM₆O₂₄H[X₂⁺ⁿM₁₀O₃₈H₄]⁻⁽¹²⁻²ⁿ⁾₆]⁻⁽⁶⁻ⁿ⁾ |
| [X₂⁺ⁿZ₄^{+m}M₁₈O₇₀H₄]^{-(28-2n-4m)} | [X⁺ⁿM₁₂O₄₂]⁻⁽¹²⁻ⁿ⁾ |
| [X₂⁺ⁿM₅O₂₃]⁻⁽¹⁶⁻²ⁿ⁾ | [X⁺ⁿZ^{+m}M₁₁O₄₀]^{-(14-n-m)} |
| [X⁺ⁿM₉O₃₂]⁻⁽¹⁰⁻ⁿ⁾ | [(RAs)₂M₅O₂₄]⁻⁴ |
| [(RAs)₂M₆O₂₄]⁻⁴ | |

Legend: M = Mo or W; R = CH₃ or C₆H₅.

Another class of materials that can function as reversibly excitable photoredox reagents is the class of photoreducible dyes. Some specific types of dyes includes: phenazine dyes, such as phenosafranine; xantchene dyes, such as eosin and erythrosin; and thiazine dyes, such as thionine, Methylene Blue, Toluidine Blue, Methylene Green, Methylene Azure, Thiocarmine R, Gentianine, C.I. Basic Blue, C.I. Basic Blue 24, and C.I. Basic Blue 25. Rhodamine B, Victoria Blue B, and chlorophyll are other suitable photoreducible dyes. A preferred class of dyes of electrolytes useful in photogalvanic systems is the class of thiazine dyes, and thionine is an especially preferred dye because of the outstanding potential offerred by iron-thionine photogalvanic systems. Thionine is a purple dye, and a purple solution of thionine and iron salts, when exposed to sunlight, becomes colorless due to the formation of leucothionine. The purple color reappears in a matter of seconds when th solution is removed from the sunlight. This sequence can be performed repeatedly which demonstrates the reversibility of electrolyte systems based upon iron-thionine.

Another suitable class of materials that can function as suitable excitable photoredox reagents is the class of photooxidizable dyes. Certain transition metal complexes which can be elevated to an excited state by solar energy are included in this class. It has been demonstrated, for example, that complexes of ruthenium (II) or Osmium (II) such as tris (2,2′-bipyridine) ruthenium or tris (2,2′-bipyrine) osmium (II), can be elevated to an excited state by sunlight. Quenching of the excited state can then be done with oxidizing agents, including O₂,Fe⁺³, Co(phen)⁺³, Ru(NH₃)₆⁺³, Os(bpy)₃⁺³, and Fe(CN³)₆⁻³

In another preferred embodiment, the present invention allows the photon input to be input from inside the tube structure or the photon input can enter from one end of the apparatus. Further, the design of the light baffle allows for a gating effect whereby a portion of the photon input can be permitted to reach the cathode region, if desired. Additionally the baffle can be used to control the mixing of the solution in the two regions of the reactor.

In still another preferred embodiment, the photogalvanic system or apparatus of the present invention comprises: (1) a reactor having a single chamber for housing the photogalvanic reaction; (2) a platinum electrode structure having an anode end and a cathode end; (3) at least one light baffle or device for allowing fluid flow of an aqueous electrolyte solution between two regions in the changer without concomitant transmission of light from one region to the other; (4) an input tube or conduit for charging the reactor with the aqueous electrolyte solution; (5) an outlet tube for gas capture and transmission resulting from the photogalvanic reaction; (6) a lens for capturing and focusing photon emissions from a photon or light source (in the 200 to 700 nm range, preferably at about 501.6 nm) into the reactor chamber; (7) optional curved mirror reflectors to transmit solar radiance or photon emissions back into the reactor vessel; (8) optional shrink wrap or other suitable material to separate to or more light baffles from the reactor wall; and (9) optional voltmeter, current meter or other measuring device for determining voltage, inductance, amperage, etc. Preferably, the aqueous electrolyte solution comprises water and polyoxometalate (heteropoly) catalyst. More preferably, the aqueous electrolyte solution comprises polyoxometalate (heteropoly) catalysts complexes (isopoly and heteropoly anions) of the transition metals of Groups V and VI, especially molybdenum, tungsten, and vanadium. In this embodiment, hydrogen or oxygen gas emitted during the photogalvanic reaction may be drawn from the reactor chamber and collected in an appropriate storage tank or vessel. In operation, input of the photon or light source will initiate the photogalvanic process and the production of gases.

The present invention will be further illustrated in the following, non limiting Example. The Example is illustrative only and does not limit the claimed invention regarding the materials, conditions, process parameters and the like recited herein.

### EXAMPLE

A series of experiments were carried out to examine the performance of the above apparatus upon the addition to the aqueous electrolyte solution of one of four different polyoxometalate agents (POMs). The experimental details and results are set forth in the following Table.

TABLE
PhotoGalvanic Synthesis via POMs and Platinum

| | | | Hy- | Carbon |
|---|---|---|---|---|
| | | Oxygen | drogen | Dioxide |
| No. | Apparatus Configuration | Vol % | Vol % | Vol % |
| 1. | POM: Ammonium Molybdate | 62.4 | 0.074 | Not Measured |
| | (NH₄)₆MO₇O₂₄.(N)H₂O | | | |
| | CA: Single Platinum Wire | | | |
| | Photon source: Mercury Neon | | | |
| 2. | POM: Ammonium | 20.2 | 0.052 | 0.86 |
| | Tungsto Silica Acid... | | | |
| | (NH₄)10W₁₂O₄₁.(5) H₂O | | | |
| | CA: Single Platinum Wire | | | |
| | Photon source: Mercury Neon | | | |
| 3. | POM: Tungsto Silica Acid | 10.2 | 0.009 | 0.18 |
| | H₄SiO₄WO₃.(X) H₂O | | | |
| | CA: Single Platinum Wire | | | |
| | Photon source: Mercury Neon | | | |
| 4. | POM: Tungsto Silica Acid | 17.2 | 0.013 | 0.05 |
| | H₄SiO₄WO₃.(X) H₂O | | | |
| | CA: Platinum Wire Mesh | | | |
| | Photon source: Mercury Neon | | | |

Single Platinum Wire: Diameter 0.3 mm
Platinum Wire Mesh: Mesh size 52, diameter of wire 0.1 mm, Open area 62.7%, Mesh area 100 mm², Purity 99.9%, weight 0.47 gm per 25 mm².
CA: Cathode/Anode
Photon Source: Mercury Neon with major visible and UV spectra.

Apart from the composition of the aqueous electrolyte solution, the photogalvanic apparatus of the present invention may be designed, constructed and operated in accord with principles recognized in the art. The exact nature of such elements as the electrodes, the cell enclosure, and the light source may be varied to achieved different performance characteristics in the apparatus. Although illustrative embodiments of the present invention have been described in detail, it is to be understood that the present invention is not limited to those precise embodiments, and that various changes and modifications can be effected therein by one skilled in the art without departing from the scope and spirit of the invention.

1. A photogalvanic system, comprising:
a reactor cell having a lighted region and a darkened region;
an aqueous electrolyte solution contained in the reactor cell, said aqueous electrolyte solution comprising water and a photoredox catalyst;
an electrode having a anodic end and a cathodic end, said electrode being immersed in the aqueous electrolyte solution whereby the anodic end resides in the lighted region and the cathodic end resides in the darkened region;
a light source for irradiating the contents of the lighted region with visible light; and
a baffle interposed between the lighted region and the darkened region, said baffle adapted to block light irradiated in the lighted region from entering into the darkened region and adapted to allow the aqueous electrolyte solution to flow between the lighted region and the darkened region.

2. The photogalvanic system of claim 1, wherein the catalyst comprises a polyoxometalate.

3. The photogalvanic system of claim 1, wherein the catalyst comprises a photoreducible dye.

4. The photogalvanic system of claim 1, wherein the catalyst comprises a photooxidizable dye.

5. The photogalvanic system of claim 1, wherein the electrode is platinum.

6. The photogalvanic system of claim 1, wherein the light source emits photons in a range of about 200 nm to about 700 nm.

7. The photogalvanic system of claim 1, wherein the light source emits photons in a range of about 500 nm to about 550 nm.
